(19) United States
(12) Patent Application Publication
(10) Pub. No.: US 2020/0263636 A1
(43) Pub. Date: Aug. 20, 2020

(54) Thrust Augmentation for Liquid Rocket Engines

(71) Applicant: M&J Engineering P.C., New Hyde Park, NY (US)

(72) Inventors: Asad MALIK, New Hyde Park, NY (US); Timothy Tzetsung CHEN, Palmdale, CA (US)

(21) Appl. No.: 16/795,364

(22) Filed: Feb. 19, 2020

Related U.S. Application Data
(60) Provisional application No. 62/807,244, filed on Feb. 19, 2019.

(51) Int. Cl. F02K 9/56; F02K 1/78

(52) U.S. Cl. CPC F02K 9/56; F02K 1/78

(57) ABSTRACT

The present disclosure comprises a thrust augmentation device for liquid rocket engines that will enable higher thrust throttling when launch vehicles require the additional thrust and be turned off when the additional thrust is no longer required. The present disclosure provide a higher mission-average engine specific impulse (Isp) performance by offering a greater nozzle exit area ratio and option of MR-shift in main combustion chamber. The present disclosure retains the technology advancements made in historical rocket engine development where cost and technical challenges were great, that is in the turbopump and main injector/combustion chamber, and take advantage of engine component that is least developed and understood, the nozzle section by providing a secondary propellant injection port and combustion zone to optimize liquid rocket engine performance required by launch vehicles.

### CROSS-REFERENCE TO RELATED APPLICATIONS

This application claims the benefit under 35 U.S.C. § 119(e) of U.S. Patent Application No. 62/807,244, entitled “Thrust Augmentation For Liquid Rocket Engines,” filed Feb. 19, 2019, which is incorporated herein by reference in its entirety.

### BACKGROUND

Liquid rocket engines used in the initial boost phase of launch vehicle are designed with a thrust level that is to provide adequate initial vehicle acceleration. As the vehicle ascends and drains its propellant for thrust, the vehicle gets lighter thereby requiring engines to reduce its thrust level in order to keep vehicle axial acceleration (axial G force) within design limits. The requirement for engine throttling poses a significant challenge in engine design and development often with significant cost and risk focused on the design of engine turbo machinery. Further, the desire for higher engine performance, characterized by the term Engine Specific Impulse (Isp), is constrained by 1) selection of engine performance cycle, 2) selection of engine propellant mixture ration (MR), and 3) engine nozzle exit area ratio (AR). Much of the technology advancements have been invested in engine turbopump, injector and combustor development. Additional investment in this area have only resulted in small percentage of improvement. On the other hand, little effort has been focused on improvement of nozzle performance by addressing the development challenges above. The traditional nozzle design methodology focuses on assuming completed combustion in the main combustion chamber (MCC) and as combustion gases pass through engine throat, it assumes isentropic expansion to an exit area. The nozzle wall contour design methodology is largely developed by Dr. G. V. R. Rao, commonly known as “Rao Optimal Nozzle” as the current industry design standard.

Why others have failed in improving booster engine performance is because they took a conventional thinking and approach. In order to provide a higher engine thrust, it is often accomplished by providing higher chamber pressure (Pc). This can be accomplished by either increase in turbopump performance, in the case of pump-fed engine, or by increase in the ullage pressure in propellant tank, in the case of pressure-fed engine. Turbopump development is a high cost, high development risk challenge as it often is already at state-of-art (SOA) technology after many billions of dollar was poured into this effort. Increase in propellant tank ullage pressure results in thicker propellant tank wall. This increases the inert weight of launch vehicle, thereby reducing the mass of payload to orbit performance. Attempts to increase combustion efficiency of liquid rocket engine faces the same challenge as turbopump development. The state of technology is approaching SOA with rich history of financial investment. Engine thrust is also a function of nozzle exit area ratio (AR); higher AR will result in higher engine thrust. However, the nozzle AR sizing is limited by the combustion gases exit pressure to ambient pressure ratio, called the separation criteria. If the nozzle AR is designed bigger than what the separation criteria allows, flow separation occurs at nozzle exit and could tear the nozzle apart due to pressure forces.

### SUMMARY

The present describes solutions of optimizing liquid rocket engine performance for booster engines by: 1) Provide thrust augmentation when the vehicle needed most, as in during the initial boost phase, 2) Provide the engine throttling needed when the vehicle no longer need extra boost, 3) Provide higher engine performance, Isp, throughout the boost phase of launch vehicle, and thereby 3) Provide higher payload to orbit.

The present disclosure describes a “dual bell nozzle” to a rocket engine that provides a fuel, or oxidizer, or both, injection ports at the interface between the first and second bell. The introduction of fuel or oxidizer, or both, initiates combustion reacting with combustion gases exiting from the main combustion chamber, further expand the gases to fill the second bell nozzle. By providing both combustion (heat addition) and injecting propellant (mass addition) to the second bell, this enables the engine flow expansion to have a greater nozzle exit area without the flow separation effect and by doing so the engine creates a greater thrust during liftoff. As the launch vehicle reaches a predetermined altitude where the vehicle no longer needs additional thrust provided, the injection can be turned off. At this stage, the core flow of combustion gases from main combustion chamber can expand to the higher area ratio of second bell without flow separation effect because of lower ambient pressure. As a result of expansion to a higher nozzle area ratio, the engine effective Isp is increased resulting in a greater mass of payload to orbit delivery by the launch vehicle.

The present disclosure also provides opportunity to do an oxidizer-fuel mixture ratio (MR) shift to further optimize engine Isp performance. Certain engine cycles, such as the Gas Generator cycle, operates in a non-optimum MR range in main combustion chamber because of fuel-rich mixture required in the Gas Generator. The present disclosure provides a “MR-split” by shifting additional oxidizer to secondary injection port, which allows the MR in the main combustion chamber to be closer to optimum for maximizing engine Isp. An analysis indicates as much as 10 seconds of Isp can be realized with this “MR-split” approach. (See FIG. 4).

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates the thrust augmentation concept in liquid rocket engines.

FIG. 2 illustrates engine operation mode when the secondary oxidizer/fuel injection is turned off.

FIG. 3 illustrates fuel/oxidizer injection concept.

FIG. 4 illustrates Engine specific impulse (Isp) as a function of Combustion oxidizer/fuel mixture ratio (MR).

FIGS. 5, 6 and 7 are isometric views of a triplet injector plate.

FIG. 8 is a schematic diagram of an injector and feed plate assembly.

FIG. 9 is a schematic diagram of an assembly of the triplet impinging injector.

FIG. 10 is a side view showing a thickness of the injector.

FIG. 11 is a schematic diagram of the feed plate.

Like reference numbers and designations in the various drawings indicate like elements.

### DETAILED DESCRIPTION

The terminology used herein is for the purpose of describing particular implementations only and is not intended to be limiting of the disclosure. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the term “comprises” and/or “comprising” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this disclosure belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the disclosure, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the disclosure and the claims.

A thrust augmentation device, and methods to enable liquid rocket engine thrust throttling with increased performance are discussed herein. In the following description, for the purpose of explanation, numerous specific details are set forth in order to provide a thorough understanding of the present disclosure. It will be evident, however, to one skilled in the art that the present disclosure maybe practiced without these specific details.

The present disclosure is to be considered as an exemplification of the disclosure, and is not intended to limit the disclosure to the specific implementations illustrated by the figures or description below.

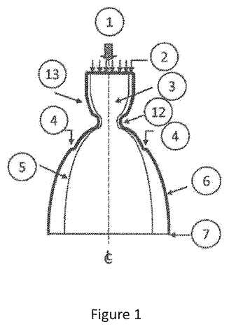

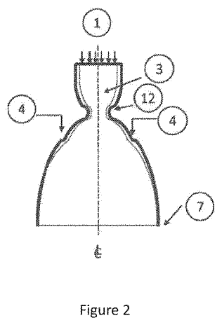

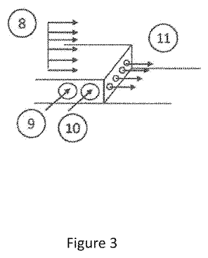

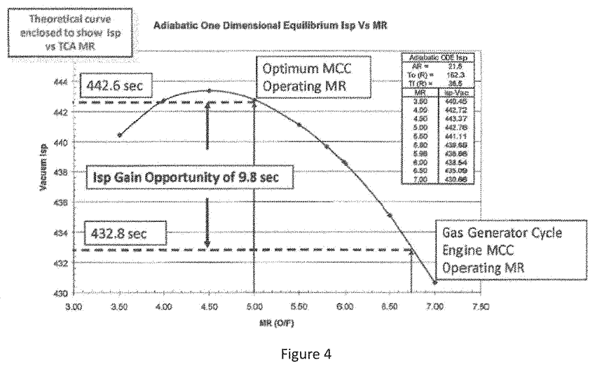

The present disclosure will now be described by referencing the appended figures representing preferred implementations. FIG. 1 illustrates the thrust augmentation concept in liquid rocket engines. The traditional single bell nozzle is replaced with a dual bell nozzle where fuel/oxidizer are injected at the interface between the first and second bell to produce higher thrust when needed. FIG. 2 illustrates engine operation mode when the secondary oxidizer/fuel injection is turned off. The core flow of main combustion gases will expand to fill the second bell nozzle contour because of lower ambient pressure at nozzle exit. FIG. 3 illustrates fuel/oxidizer injection concept. This concept provides either single propellant or bi-propellant injection. The injector design can be either co-axial or impingent type injectors. FIG. 4 illustrates Engine specific impulse (Isp) as a function of Combustion oxidizer/fuel mixture ratio (MR). This is specific to hydrogen/oxygen combustion where the optimum Isp is at the 4.5 MR. However; due to the nature of engine cycle, most Gas Generator cycle engine tend to burn at higher MR resulting at a lower engine Isp. By doing a “MR-shift” using the thrust augmentation disclosure, one can lower the MR at MCC toward a more optimum combustion.

FIG. 1 depicts the concept and principles of operation of thrust augmentation in liquid rocket engines. Standard liquid rocket engine configuration consist of Injector 1, main combustion chamber 13, and single bell nozzle 5. Injector is where fuel and oxidizer are distributed to be mixed at injector exit. Commonly incorporated in injector design is allowance for extra fuel flow distribution along the main combustion chamber wall to serve as film coolant. This is commonly called Boundary Layer Cooling (BLC) 2. The objective of BLC is to reduce heat transfer generated from main combustion gas flow 3 to chamber wall and at the engine throat 12.

The present disclosure replaces the single bell nozzle 5 with a new nozzle contour called the dual bell nozzle 6 and introduce additional injector port, called secondary injector 4, with the main injector 1 serves as primary injection port. When a higher thrust is required as in the case during lift off, additional propellant in injected at the secondary injection port and initiated combustion with boundary layer coolant flow, the combusted gases flow fill the expansion portion of second bell nozzle to generate thrust. The additional propellant can be single propellant (oxidizer) and/or bi-propellant (fuel and oxidizer) to be combusted in the expansion portion of second bell nozzle. In the case of single propellant (oxidizer) injection, the injector oxidizer is mixed and reacted with the fuel-rich boundary layer coolant flow, combustion is expected to occur due to high temperature and pressure at the mixing region. The combusted gases will then expand and filled the addition expansion volume provided by second nozzle contour. In the case of bi-propellant injection, both fuel and oxidizer are mixed at injector exit and further reacted with boundary layer fuel coolant to introduce combustion. Same as the single propellant injection case, the combusted gases will then expand and filled the addition expansion volume provided by second nozzle contour.

FIG. 2 depicts engine operation when thrust augmentation is no longer required. The vehicle will then command the shut-off of propellant at secondary injection port 4. In this case, the engine operates much like conventional liquid rocket engine with main combustion gases from main combustion chamber 3 go through engine throat 12 and expand supersonically. Because at this point of trajectory, the launch vehicle is at altitude therefore the ambient exit pressure has been significantly reduced, the main combustion gases can continue expand to a high nozzle exit area ratio provided by the dual bell nozzle contour 7. Because the flow now expands to a higher nozzle area ration 7, this increases the engine specific impulse, Isp, performance. This increase in engine performance can result in a high mass of payload to orbit capacity for launch vehicles.

The present disclosure provide liquid rocket engine a greater performance capability for launch vehicle. It provide additional thrust when the launch vehicle requires it most, during lift off phase of its flight trajectory, and able to throttle back when the thrust is no longer required. At the same time, because a higher nozzle exit area ratio, the present disclosure provide rocket engine a higher engine specific impulse, Isp, performance throughout ascent phase of flight. The increase in engine performance can result in a high mass of payload to orbit capacity for launch vehicles.

FIG. 3 illustrates fuel/oxidizer injection concept of operation. Fuel and/or oxidizer, or both is injected tangentially to the flow direction to mix with upstream boundary layer coolant (BLC) 8. The BLC flow is supersonic at this point. The fuel/oxidizer injection can be sonic or supersonic injection. 11. The mixing occurs in the shear layer between two flow streams. Auto-ignition will occur due to the temperature and pressure in the local flow field. Flame holding will take place in the recirculating region, such as the base region of injector, and flame propagation will take place in downstream supersonic flow.

The present disclosure provides a higher engine performance by “MR-Shift”. In some engine cycles, such as the gas generator cycle, the oxidizer/fuel ratio, called the MR, is often not optimal in main combustion chamber because additional fuel rich mixture is needed for combustion inside of gas generator. As result, the MR in main combustion chamber is often at sub-optimal for engine Isp performance. FIG. 4 illustrates this effect for a Hydrogen/Oxygen propellant combination. The engine main combustion chamber (MCC) is operating at 6.75MR while the optimal MR is at 4.5. By diverting additional oxidizer flow to thrust augmentation, the MR in MCC can be shifted closer to 4.5 thereby increase engine Isp simply by shifting the MR distribution in MCC.

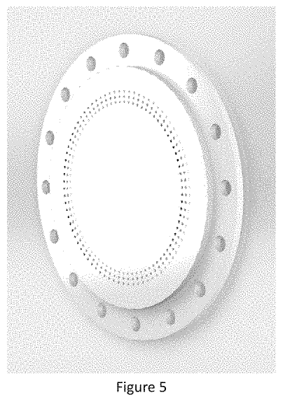

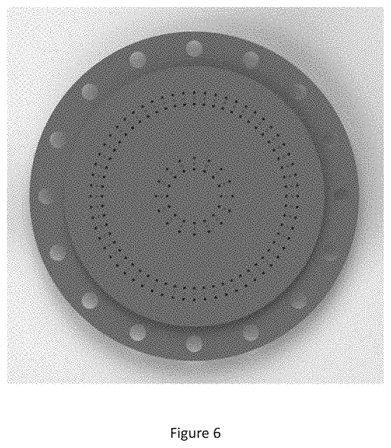

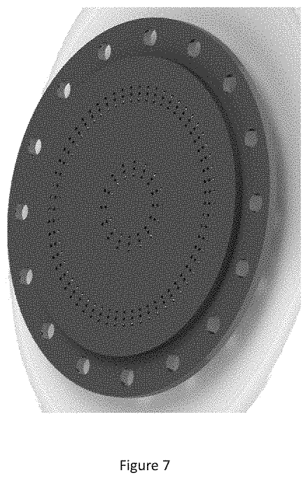

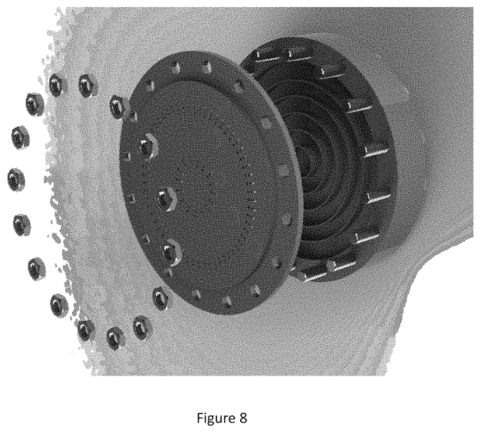

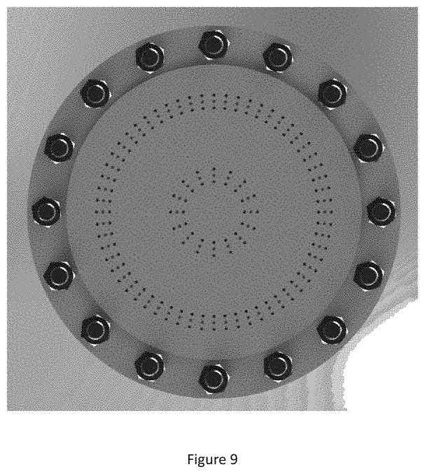

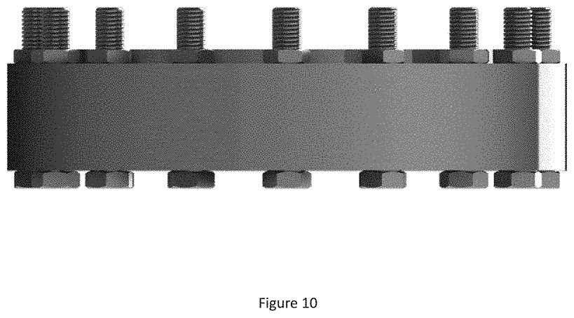

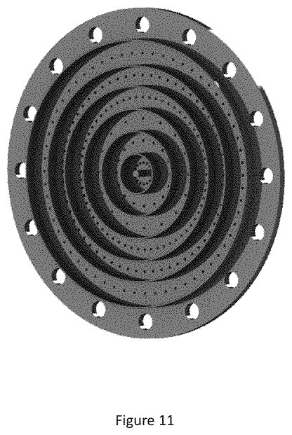

FIGS. 5, 6 and 7 are isometric views of a triplet injector plate. FIG. 8 is a schematic diagram of an injector and feed plate assembly. FIG. 9 is a schematic diagram of an assembly of the triplet impinging injector. FIG. 10 is a side view showing a thickness of the injector. FIG. 11 is a schematic diagram of the feed plate. FIGS. 5-11 disclose features of a primary triplet injector design. The injector of a launch vehicle engine is an important part of an engine. Its impact on the engine is very significant and no other component of a rocket engine has a greater impact then the primary injector. The specific impulse (Is) is a measurement of how fast the propellant is ejected out of the engine. A rocket with a high specific impulse doesn't need as much fuel as a rocket with low specific impulse. The higher the specific impulse, the more push obtained for the fuel that rushes out, like the engine's fuel mileage. It is used to figure out the total amount of velocity change (termed ‘Delta-V’) the vehicle is capable of using the Tsiolkovsky rocket equation.

The measure of delivered performance is the number of pounds of thrust provided per pound of propellant consumed per second. Each percentage point loss in combustion efficiency c* means a loss of the same magnitude in overall Is propulsive efficiency.

$${c}^{*} = \frac{{( {P}_{c} )}_{n s} {A}_{t} g}{{W}_{tc}}$$

In the foregoing equation, c* is the characteristic velocity which measures combustion performance in a given thrust chamber in m/s or ft/s. (Pc)ns is the chamber pressure in Pascal or psi. At is the area of the throat in square meters or square inches. “g” is acceleration due to gravity. W_{tc} is mass flow rate of the engine in kg/s or slugs/s.

The stability and performance of a launch vehicle engine is very critical. These parameters are determined from atomization, mixing and combustion process. The primary injector in a liquid rocket engine exerts full control over these processes. One important function of the primary injector is to mix all the propellants to provide a suitable performance in a short length, followed by atomization and mixing so that the size and weight of the pressure vessels can be minimized. The injector implementation into a liquid rocket engine then determines the percentage of theoretical performance of the nozzle that can be achieved. A poor injector performance causes unburnt propellant to leave the engine giving unsatisfactory performance. Injectors are designed with a set number of small diameter holes arranged carefully in an optimal pattern design for a specific engine design in which fuel and oxidizer travels. The speed of the flow is determined by the square root of the pressure drop across the injectors, the shape of the hole and density of propellant in this case we are using LOX/Propane or LOX/Methane, LOX/Propane can give our vehicle higher volumetric efficiency. By using a novel propellant combination the injectors performance can be improved by superior propellant combustion, increasing the mass flow rate or by reducing the size and increasing the number of orifices on the injector plate.

A triplet injector, unlike a doublet impinging injector, uses different fuel and oxidizer densities and velocities; therefore, being more efficient than a doublet impinging injector. Thus, the atomization is more dense as well as the number of droplets have increased. In addition, the streamline pattern for the impinging injectors angle is 30 degrees between the oxidizer and horizontal axis as well as fuel and horizontal axis. The orifices have been arranged in two grids of concentric circles to create a uniform combustion and also to keep the minimum distance between the holes under safe limits. The inner circle grid has 22 fuel and 36 oxidizer holes. The outer circle grid has 52 fuel and 116 oxidizer holes.

An analog controller designed with custom software can be used to increase or decrease, for example, throttle up or throttle down, the thrust on the launch vehicle augmented engine. The analog controller will allow for controlled powered landing and will also help the vehicle reach a higher delta V.

Thus, particular implementations of the subject matter have been described. Other implementations are within the scope of the following claims.

1. A thrust augmentation device for liquid rocket engine that will enable higher thrust throttling capability also with a higher mission-average engine Isp performance, the device comprising:
a dual bell nozzle;
a secondary propellant injection port at the first and second bell nozzle interface;
the propellant injection can be single propellant or bi-propellant; and
the injection port can be sonic-injection port or supersonic-injection port.

2. The device of claim 1, further comprising an analog controller coupled to the device, the analog controller configured to throttle up or throttle down thrust on the device.

3. A thrust augmentation device for liquid rocket engine that enables propellant flow distribution to main combustion chamber resulting in a higher engine specific impulse (Isp) performance.
